(19) United States
(12) Patent Application Publication
(10) Pub. No.: US 2026/0301213 A1
(43) Pub. Date: Oct. 1, 2026

(54) SYSTEM FOR ESTIMATING POSITION OF OBJECT IN FACILITY

(71) Applicant: TOYOTA JIDOSHA KABUSHIKI KAISHA, Toyota-shi (JP)

(72) Inventors: Takuro SAWANO, Nisshin-shi (JP); Yuhei NAGAFUCHI, Nagoya-shi (JP)

(73) Assignee: TOYOTA JIDOSHA KABUSHIKI KAISHA, Toyota-shi (JP)

(21) Appl. No.: 19/464,958

(22) Filed: Jan. 30, 2026

(30) Foreign Application Priority Data
Mar. 26, 2025 (JP) 2025-051772

(51) Int. Cl. G06T 7/70; G05D 1/249; G05D 107/70; G05D 109/10; G05D 111/10; G06Q 10/20

(52) U.S. Cl. CPC G06T 7/70; G05D 1/249; G06Q 10/20; G05D 2107/70; G05D 2109/10; G05D 2111/10; G06T 2207/30252

(57) ABSTRACT

A system that estimates a position of an object in a facility includes: an acquisition unit that acquires image data output by a camera fixed in the facility, the image data including the object and a reference object provided in the facility; a calculation unit that calculates a shift amount between a prespecified reference position of the reference object in the acquired image data and a position of the reference object in the acquired image data; and an estimation unit that estimates the position of the object using the acquired image data and the calculated shift amount.

### CROSS-REFERENCE TO RELATED APPLICATION

This application claims priority to Japanese Patent Application No. 2025-051772 filed on Mar. 26, 2025. The disclosure of the above-identified application, including the specification, drawings, and claims, is incorporated by reference herein in its entirety.

### BACKGROUND

### 1. Technical Field

The present disclosure relates to a system that estimates a position of an object in a facility.

### 2. Description of Related Art

Japanese Unexamined Patent Application Publication (Translation of PCT Application) No. 2017-538619 (JP 2017-538619 A) discloses a technology that makes a vehicle travel autonomously or under remote control in a manufacturing process of the vehicle. In such a technology, image data output from a camera provided in a facility is used to estimate the position in the real space of an object included in the image data. This estimation is performed by associating a reference point in the image data and a coordinate in the real space with each other in advance and using a correspondence relationship between a coordinate in the image data and the real coordinate.

### SUMMARY

Due to aging deterioration of a support member that supports a camera, vibration caused by equipment work, etc., the position of the camera can shift from a prespecified position. If position estimation of an object is performed while the position of the camera has shifted, the correspondence relationship between the coordinate in the image data and the real coordinate also shifts, which may reduce the accuracy of the position estimation.

The present disclosure can be realized in the following forms.

(1) One form of the present disclosure provides a system that estimates a position of an object in a facility. This system includes: an acquisition unit that acquires image data output by a camera fixed in the facility, the image data including the object and a reference object provided in the facility; a calculation unit that calculates a shift amount between a prespecified reference position of the reference object and a position of the reference object in the acquired image data; and an estimation unit that estimates the position of the object using the acquired image data and the calculated shift amount.

Since the system of this form includes the calculation unit that calculates the shift amount between the prespecified reference position of the reference object and the position of the reference object in the image data, and the estimation unit that estimates the position of the object using the image data and the calculated shift amount, it is less likely that the accuracy of position estimation decreases due to a shift of the correspondence relationship between the reference object and the coordinate in the real space resulting from a shift of the position of the camera.

(2) In the system of the above-described form, the reference object may be a marker showing a prespecified figure.

In the system of this form, since the reference object is a marker showing a prespecified figure, the reference object can be relatively easily prepared.

(3) In the system of the above-described form, the figure may be a cross.

In the system of this form, the figure is a cross and therefore includes relatively large numbers of edges and corners for extracting feature points compared with a figure such as a triangle or a circle. Thus, a larger number of correspondence relationships between a feature point of the reference object and a coordinate in the real space can be set, which can improve the accuracy of position estimation.

(4) In the system of the above-described form, a plurality of reference objects may be provided.

In the system of this form, a plurality of reference objects is provided, which can further improve the accuracy of position estimation.

(5) The system of the above-described form may further include a shift amount recording unit that records the calculated shift amount, and a notification unit that, when a prespecified condition about the recorded shift amount is met, notifies that maintenance and inspection of the camera is necessary.

Since the system of this form includes the shift amount recording unit that records the calculated shift amount, and the notification unit that, when the prespecified condition about the recorded shift amount is met, notifies that maintenance and inspection of the camera is necessary, it is possible to know that maintenance and inspection of the camera is necessary by setting, as the prespecified condition, a condition under which maintenance and inspection of the camera becomes necessary.

(6) In the system of the above-described form, the condition may include that the recorded shift amount is larger than a prespecified shift amount.

In the system of this form, the condition includes that the recorded shift amount is larger than the prespecified shift amount. Thus, setting, as the prespecified shift amount, such a shift amount as maintenance and inspection of the camera becomes necessary allows the notification unit to notify that maintenance and inspection of the camera is necessary when a shift amount larger than that shift amount is calculated.

(7) In the system of the above-described form, the condition may include that a frequency with which the recorded shift amount has become larger than a prespecified shift amount is higher than a prespecified frequency.

In the system of this form, the condition includes that the frequency with which the recorded shift amount has become larger than the prespecified shift amount is higher than a prespecified frequency. Thus, setting, as the prespecified frequency, such a frequency as maintenance and inspection of the camera becomes necessary allows the notification unit to notify that maintenance and inspection of the camera is necessary when a frequency higher than that frequency is detected.

(8) In the system of the above-described form, the condition may include that an increase rate of the recorded shift amount is higher than a prespecified increase rate.

In the system of this form, the condition includes that the increase rate of the recorded shift amount is higher than a prespecified increase rate. Thus, setting, as the prespecified increase rate, such an increase rate as maintenance and inspection of the camera becomes necessary allows the notification unit to notify that maintenance and inspection of the camera is necessary when an increase rate higher than that increase rate is detected.

Other than the above-described forms as a system, the present disclosure can also be realized in the forms of, for example, a position estimation device and a position estimation method of an object, a program for realizing this method, a non-transitory recording medium in which the program is recorded, a program product, etc. For example, the program product may be provided as a recording medium in which the program is recorded, or may be provided as a program product that can be distributed through a network.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual view for describing a system in an embodiment;

FIG. 2 is a block diagram showing the configuration of the system;

FIG. 3 is a flowchart showing a processing procedure of vehicle travel control in the embodiment;

FIG. 4 is a flowchart showing a procedure of object position estimation; and

FIG. 5 is a flowchart showing a procedure of a maintenance and inspection notification process.

### DETAILED DESCRIPTION OF EMBODIMENTS

### A. Embodiment

### Overview of System 50

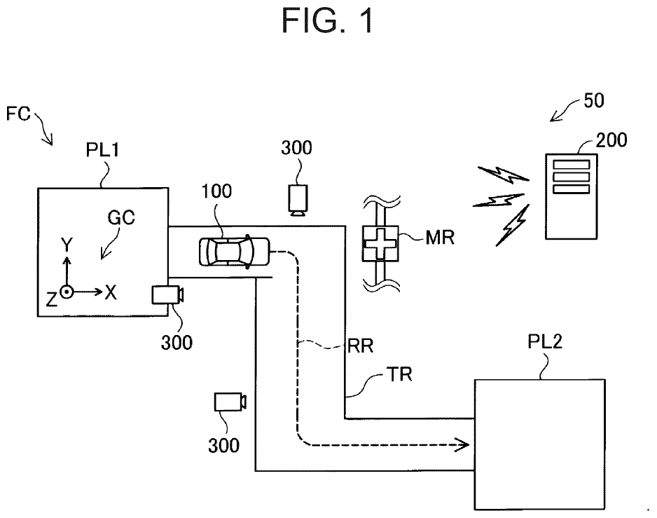

FIG. 1 is a conceptual view for describing a system 50 in an embodiment. The system 50 is used to estimate the position of an object in a facility. The system 50 is also used to make a vehicle 100 as a movable body travel by unmanned driving. The facility in this embodiment is a factory FC. In the factory FC, manufacturing of the vehicle 100 is performed. Objects as targets of position estimation include the vehicle 100 and objects present around the vehicle 100.

In the present disclosure, “movable body” means an object that can move, and is, for example, a vehicle or an electric vertical takeoff and landing aircraft (so-called flying car). The vehicle may be a vehicle that travels on a wheel or a vehicle that travels on an endless track, and is, for example, a passenger car, a truck, a bus, a two-wheel vehicle, a four-wheel vehicle, or a construction vehicle. The term “vehicle” covers a battery electric vehicle (BEV), a gasoline vehicle, a hybrid electric vehicle, and a fuel cell electric vehicle. When the movable body is other than a vehicle, the expressions “vehicle” and “car” in the present disclosure can be replaced with “movable body” as appropriate, and the expression “travel” can be replaced with “move” as appropriate.

The vehicle 100 is configured to be able to travel by unmanned driving. “Unmanned driving” means driving that does not rely on an occupant's travel operation. A travel operation means an operation relating to at least one of “running,” “turning,” and “stopping” of the vehicle 100. Unmanned driving is realized by automatic or manual remote control using a device located outside the vehicle 100 or by autonomous control of the vehicle 100. An occupant who does not perform a travel operation may be on board the vehicle 100 traveling by unmanned driving. Examples of occupants who do not perform a travel operation include a person who is just sitting in a seat of the vehicle 100, and a person who is performing work different from a travel operation, such as installation, inspection, or an operation of switches, while riding the vehicle 100. Driving by an occupant's travel operation is sometimes called “manned driving.”

In the present specification, “remote control” includes “fully remote control” in which all actions of the vehicle 100 are fully determined from the outside of the vehicle 100, and “partial remote control” in which some of actions of the vehicle 100 are determined from the outside of the vehicle 100. “Autonomous control” includes “fully autonomous control” in which the vehicle 100 autonomously controls its actions without receiving any information from a device outside the vehicle 100, and “partial autonomous control” in which the vehicle 100 autonomously controls its actions using information received from a device outside the vehicle 100.

A reference coordinate system of the factory FC is a global coordinate system GC, and an arbitrary position in the factory FC can be expressed by X, Y, and Z coordinates in the global coordinate system GC. The factory FC includes a first place PL1 and a second place PL2. The first place PL1 and the second place PL2 are connected to each other by a travel road TR on which the vehicle 100 can travel. In the first place PL1 and the second place PL2, various steps for manufacturing the vehicle 100 are executed. These steps include, for example, an assembly step, a painting step, a washing step, and an inspection step. The vehicle 100 moves from the first place PL1 to the second place PL2 through the travel road TR by unmanned driving.

### Configuration of System 50

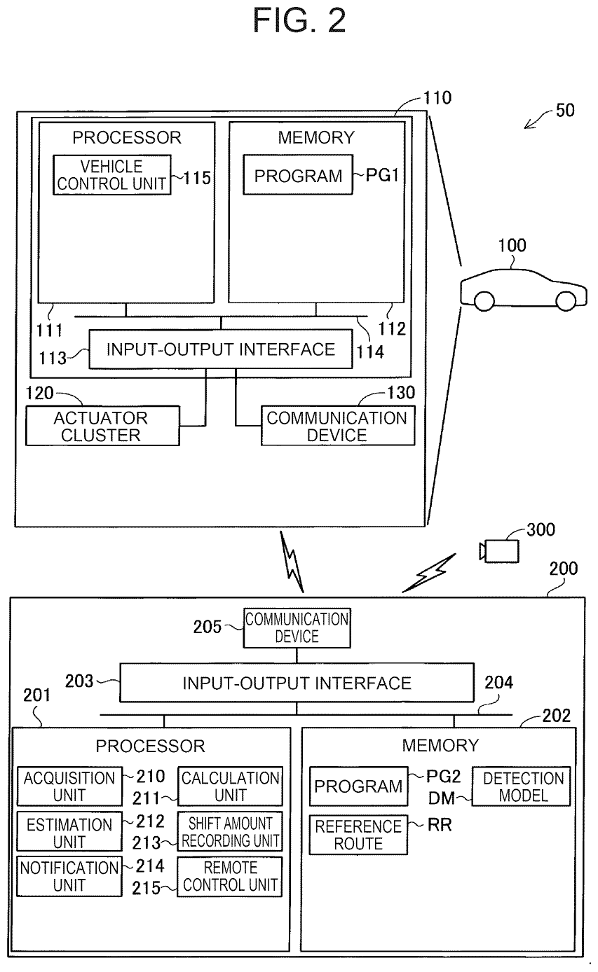

FIG. 2 is a block diagram showing the configuration of the system 50. The system 50 includes the vehicle 100, a server 200, and one or more cameras 300.

The vehicle 100 includes a vehicle control device 110 that controls parts of the vehicle 100, an actuator cluster 120 including one or more actuators that are driven under control by the vehicle control device 110, and a communication device 130 for communicating with external devices, including the server 200, by wireless communication. The actuator cluster 120 includes an actuator of a drive device for accelerating the vehicle 100, an actuator of a steering device for changing an advancing direction of the vehicle 100, and an actuator of a braking device for decelerating the vehicle 100.

The vehicle control device 110 is formed by a computer including a processor 111, a memory 112, an input-output interface 113, and an internal bus 114. The processor 111, the memory 112, and the input-output interface 113 are connected to one another through the internal bus 114 so as to be bidirectionally communicable with one another. The actuator cluster 120 and the communication device 130 are connected to the input-output interface 113. The processor 111 realizes various functions including a function as a vehicle control unit 115 by executing a program PG1 stored in the memory 112.

The vehicle control unit 115 makes the vehicle 100 travel by controlling the actuator cluster 120. The vehicle control unit 115 can make the vehicle 100 travel by controlling the actuator cluster 120 using a travel control signal received from the server 200. The travel control signal is a control signal for making the vehicle 100 travel. In this embodiment, the travel control signal includes an acceleration rate and a steering angle of the vehicle 100 as parameters. In another embodiment, the travel control signal may include a speed of the vehicle 100 as a parameter instead of or in addition to the acceleration rate of the vehicle 100.

The camera 300 is fixed in the factory FC as the facility, and outputs image data including an object inside the factory FC. The camera 300 is, for example, hung from a ceiling of the factory FC and fixed. A plurality of cameras 300 is provided in the factory FC. The camera 300 in the present disclosure photographs an inside of a fixed angle of view without swiveling, and outputs image data. The camera 300 includes a communication device (not shown), and can communicate with other devices, including the server 200, by wired communication or wireless communication.

The camera 300 in the present disclosure photographs a reference object provided in the factory FC. That is, the camera 300 outputs image data including an object in the factory FC and the reference object. The reference object in this embodiment is a marker MR showing a cross. The marker MR is, for example, fixed on a column in the factory FC. The function of the marker MR will be described later.

The server 200 is formed by a computer including a processor 201, a memory 202, an input-output interface 203, and an internal bus 204. The processor 201, the memory 202, and the input-output interface 203 are connected to one another through the internal bus 204 so as to be bidirectionally communicable with one another. A communication device 205 for communicating with various devices outside the server 200 is connected to the input-output interface 203. The communication device 205 can communicate with the vehicle 100 by wireless communication, and can communicate with each camera 300 by wired communication or wireless communication. The processor 201 realizes various functions including functions as an acquisition unit 210, a calculation unit 211, an estimation unit 212, a shift amount recording unit 213, a notification unit 214, and a remote control unit 215 by executing a program PG2 stored in the memory 202.

The acquisition unit 210 acquires image data output by the camera 300. The acquired image data includes an object in the factory FC and the marker MR.

The calculation unit 211 calculates a shift amount between a prespecified reference position of the marker MR in the image data and a position of the reference object in the image data acquired by the acquisition unit 210. Due to the influence of vibration, aging deterioration, etc. of a support member or the like that supports the camera 300, the camera 300 can shift from a predetermined position. The calculation unit 211 calculates such a shift amount. The calculation of the shift amount is performed by comparing the prespecified reference position of the marker MR in the image data and the actual position of the reference object acquired by the acquisition unit 210. The reference position is expressed by, for example, an x coordinate and a y coordinate in the image data. Specifically, the reference position is a coordinate of a feature point belonging to the marker MR. Similarly, the position of the reference object in the image data is a coordinate of a feature point belonging to the reference object in the image data. The shift amount is represented as an amount of displacement of the x coordinate and the y coordinate by comparing the coordinates of the feature point belonging to the marker MR and the feature point of the reference object.

Using the image data acquired by the acquisition unit 210 and the shift amount calculated by the calculation unit 211, the estimation unit 212 estimates the position of the object included in the image data. The position estimation of the object is performed by expressing the positional relationship between the marker MR and the object as the target of the position estimation in the image data by coordinates in the real space. Specifically, a feature point of the marker MR located at a prespecified reference position and a coordinate in the real space are associated with each other in advance, and a coordinate transformation matrix is calculated from the correspondence relationship therebetween. Further, the coordinate transformation matrix is corrected using the shift amount calculated by the calculation unit 211. This correction is executed such that the same position is estimated as the position that is estimated when the shift amount is zero. The estimation unit 212 estimates the position of the object using the transformation matrix thus corrected. As a result, the position of the object that takes the shift amount into account is calculated. When the shift amount calculated by the calculation unit 211 is zero, the estimation unit 212 estimates the position of the object without performing correction.

The shift amount recording unit 213 records the shift amount calculated by the calculation unit 211 in the memory 202. The shift amount is recorded in chronological order in association with time at which that shift amount has been calculated.

When a prespecified condition about the shift amount recorded in the shift amount recording unit 213 is met, the notification unit 214 notifies that maintenance and inspection of the camera 300 is necessary. The prespecified condition in this embodiment is at least one of the following three:
(1) that the recorded shift amount is larger than a prespecified shift amount;
(2) that a frequency with which the recorded shift amount has become larger than the prespecified shift amount is higher than a prespecified frequency; and
(3) that an increase rate of the shift amount is higher than a prespecified increase rate

An arbitrary value is set as the prespecified shift amount in Condition (1). Such a shift amount can be, for example, experimentally obtained as a shift amount at which maintenance and inspection of the camera 300 becomes necessary.

The prespecified shift amount in Condition (2) may be the same as or different from the prespecified shift amount in Condition (1). When the recorded shift amount is larger than the prespecified shift amount, a worker performs maintenance and inspection of the camera 300 to correct this shift. However, even when maintenance and inspection has been performed, the recorded shift amount can become larger than the prespecified shift amount again. In such a case, the cause of the shift of the camera 300 is highly likely to be the environment where the camera 300 is disposed. Condition (2) is set to detect a shift of the camera 300 due to the environment. The prespecified frequency is, for example, the number of times per month that the recorded shift amount has become larger than the prespecified shift amount. The prespecified frequency may be calculated as the number of times in an arbitrary period.

An arbitrary value is set as the prespecified increase rate in Condition (3). Such an increase rate can be, for example, experimentally obtained as an increase rate at which maintenance and inspection of the camera 300 becomes necessary. The increase rate is calculated, for example, once every month. The increase rate may be calculated in an arbitrary period.

When at least one of Conditions (1) to (3) is met, the notification unit 214notifies that maintenance and inspection of the camera 300 is necessary. The notification is executed by, for example, a display device, such as a display. Without being limited to a display device, the notification may be executed by an arbitrary device, such as a speaker.

The remote control unit 215 generates a travel control signal for controlling the actuator cluster 120 of the vehicle 100 using detection results of various sensors including the cameras 300 and transmits the travel control signal to the vehicle 100 to thereby make the vehicle 100 travel under remote control. The remote control unit 215 may generate and output, not only the travel control signal, but also control signals for controlling actuators that activate various auxiliaries included in the vehicle 100 and various devices, such as a wiper, a power window, and a lamp. That is, the remote control unit 215 may activate such various devices and various auxiliaries by remote control.

### Travel Control of Vehicle 100

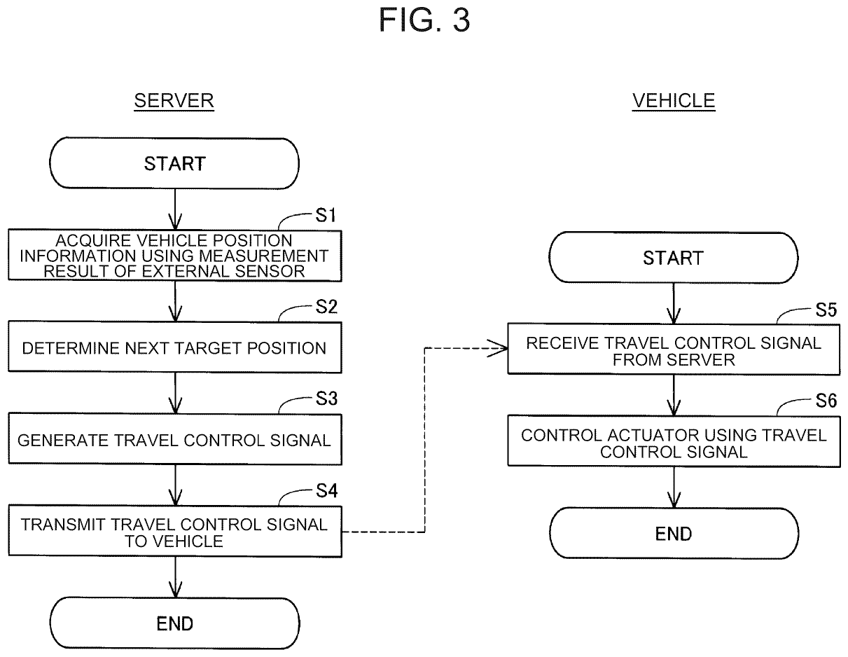

FIG. 3 is a flowchart showing a processing procedure of travel control of the vehicle 100 in the embodiment. The travel control is a process for making the vehicle 100 travel inside the factory FC by unmanned driving. The travel control is executed when a switch of the vehicle 100 is turned on inside the factory FC. In the processing procedure of FIG. 3, the processor 201 of the server 200 functions as the remote control unit 215 by executing the program PG2. The processor 111 of the vehicle 100 functions as the vehicle control unit 115 by executing the program PG1.

In step S1, the processor 201 of the server 200 acquires vehicle position information using a detection result of the camera 300. The vehicle position information is position information serving as a basis for generating a travel control signal. In this embodiment, the vehicle position information includes the position and the direction of the vehicle 100 in the global coordinate system GC of the factory FC.

Specifically, in step S1, the position of the vehicle 100 is estimated by, for example, detecting the contour of the vehicle 100 using three-dimensional point cloud data, calculating a coordinate of a positioning point of the vehicle 100 in a local coordinate system, and converting the calculated coordinate into a coordinate in the global coordinate system GC. The contour of the vehicle 100 can be detected by, for example, inputting the three-dimensional point cloud data into a detection model DM that uses artificial intelligence. The detection model DM is, for example, prepared inside the system 50 or outside the system 50 and stored in the memory 202 of the server 200 in advance. Examples of the detection model DM include a leaned machine learning model that has learned so as to realize either semantic segmentation or instance segmentation. As this machine learning model, for example, a convolutional neural network (hereinafter “CNN”) that has learned by supervised learning using a learning dataset can be used. The learning dataset has, for example, a plurality of training images including the vehicle 100, and a label indicating whether each region in a training image is a region showing the vehicle 100 or a region showing an object other than the vehicle 100. During learning of the CNN, it is preferable that parameters of the CNN be updated by back-propagation (the error back-propagation method) so as to reduce errors between an output result produced by the detection model DM and the label. The processor 201 can acquire the direction of the vehicle 100 by, for example, estimating the direction based on the direction of a movement vector of the vehicle 100 calculated from a change in the position of a feature point of the vehicle 100 between frames of the three-dimensional point cloud data using the optical flow method. The vehicle position information may be acquired by template matching using reference point cloud data. The reference point cloud data is stored in the memory 202 in advance. In step S1, the position information of the object estimated by the estimation unit 212 may be further used. The vehicle position information is acquired using the position and the direction of the vehicle 100 thus estimated.

In step S2, the processor 201 of the server 200 determines a target position for which the vehicle 100 should head next. In this embodiment, the target position is represented by X, Y, and Z coordinates in the global coordinate system GC. In the memory 202 of the server 200, a reference route RR that is a route along which the vehicle 100 should travel is stored in advance. The route is represented by a node indicating a place of departure, a node indicating a pass point, a node indicating a destination, and links connecting the nodes to one another. Using the vehicle position information and the reference route RR, the processor 201 determines the target position for which the vehicle 100 should head next. The processor 201 determines the target position on the reference route RR, at a point further ahead than the current location of the vehicle 100.

In step S3, the processor 201 of the server 200 generates a travel control signal for making the vehicle 100 travel toward the determined target position. The processor 201 calculates a traveling speed of the vehicle 100 from a transition of the position of the vehicle 100 and compares the calculated traveling speed and a target speed. On the whole, when the traveling speed is lower than the target speed, the processor 201 determines the acceleration rate such that the vehicle 100 accelerates, and when the traveling speed is higher than the target speed, determines the acceleration rate such that the vehicle 100 decelerates. When the vehicle 100 is located on the reference route RR, the processor 201 determines the steering angle and the acceleration rate such that the vehicle 100 does not deviate from the reference route RR. When the vehicle 100 is not located on the reference route RR, in other words, when the vehicle 100 has deviated from the reference route RR, the processor 201 determines the steering angle and the acceleration rate such that the vehicle 100 returns to the reference route RR.

In step S4, the processor 201 of the server 200 transmits the generated travel control signal to the vehicle 100. The processor 201 repeats acquisition of the vehicle position information, determination of the target position, generation of the travel control signal, transmission of the travel control signal, etc. on a predetermined cycle.

In step S5, the processor 111 of the vehicle 100 receives the travel control signal transmitted from the server 200. In step S6, the processor 111 of the vehicle 100 controls the actuator cluster 120 using the received travel control signal to thereby make the vehicle 100 travel at the acceleration rate and the steering angle indicated in the travel control signal. The processor 111 repeats reception of the travel control signal and control of the actuator cluster 120 on a predetermined cycle. The system 50 in this embodiment can make the vehicle 100 travel under remote control and move the vehicle 100 without using transport equipment, such as a crane or a conveyor.

### Object Position Estimation

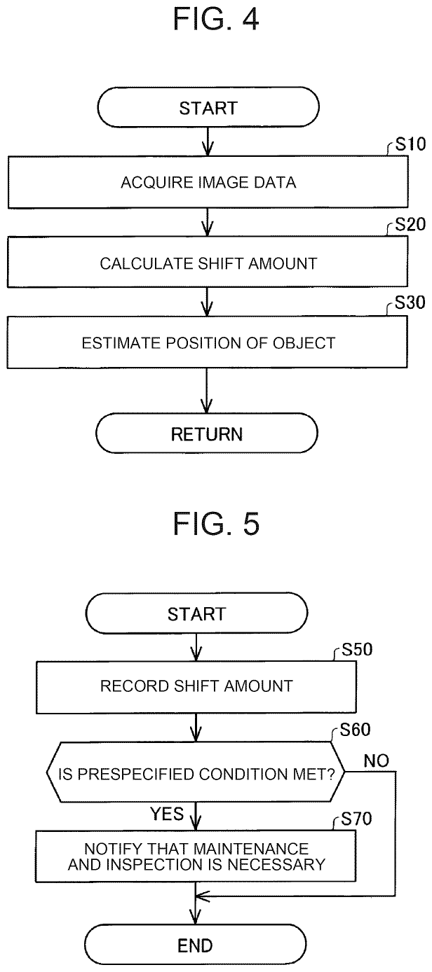

FIG. 4 is a flowchart showing a procedure of object position estimation. The procedure shown in FIG. 4 is executed to estimate the position of an object in the factory FC. The procedure shown in FIG. 4 is repeatedly executed during operation of the factory FC.

In step S10, the acquisition unit 210 acquires image data. The image data is output by the camera 300. The image data includes the marker MR as the reference object and an object as the target of position estimation.

In step S20, the calculation unit 211 calculates the shift amount between the prespecified reference position of the marker MR and the position of the marker MR in the image data acquired in step S10.

In step S30, the estimation unit 212 estimates the position of the object using the image data acquired in step S10 and the shift amount calculated in step S20.

The estimated position of the object is used, for example, to acquire the vehicle position information in step S1 shown in FIG. 3. Further, the estimated position of the object is used to create map information for making the vehicle 100 travel by unmanned driving.

### Maintenance and Inspection Notification Process

FIG. 5 is a flowchart showing a procedure of a maintenance and inspection notification process. The procedure shown in FIG. 5 is executed to notify the timing of maintenance of the camera 300. The maintenance and inspection notification process is repeatedly executed on a prespecified cycle while the procedure of object position estimation shown in FIG. 4 is executed.

In step S50 shown in FIG. 5, the shift amount recording unit 213 records the shift amount calculated in step S20 shown in FIG. 4. The shift amount is associated with the calculated time and recorded in chronological order.

In step S60 shown in FIG. 5, the notification unit 214 determines whether a prespecified condition about the shift amount recorded in step S50 is met. In this embodiment, the notification unit 214 determines whether at least one of Conditions (1) to (3) described above is met. When none of Conditions (1) to (3) is met (step S60: NO), the maintenance and inspection notification process is ended.

When at least one of Conditions (1) to (3) is met (step S60: YES), in step S70, the notification unit 214 notifies that maintenance and inspection of the camera 300 is necessary.

Since the system 50 of the above-described embodiment includes the calculation unit 211 that calculates the shift amount between the prespecified reference position of the reference object and the position of the reference object in the image data, and the estimation unit 212 that estimates the position of the object using the image data and the calculated shift amount, it is less likely that the accuracy of position estimation decreases due to a shift of the correspondence relationship between the reference object and the coordinate in the real space resulting from a shift of the position of the camera 300.

In the system 50 of the embodiment, since the reference object is the marker MR showing a prespecified figure, the reference object can be relatively easily prepared.

In the system 50 of the embodiment, the prespecified figure is a cross and therefore includes relatively large numbers of edges and corners for extracting feature points compared with a figure such as a triangle or a circle. Thus, a larger number of correspondence relationships between a feature point of the reference object and a coordinate in the real space can be set, which can improve the accuracy of position estimation.

Since the system 50 of the embodiment includes the shift amount recording unit 213 that records the calculated shift amount, and the notification unit 214 that, when a prespecified condition about the recorded shift amount is met, notifies that maintenance and inspection of the camera 300 is necessary, it is possible to know that maintenance and inspection of the camera 300 is necessary by setting, as the prespecified condition, a condition under which maintenance and inspection of the camera 300 becomes necessary.

In the system 50 of the embodiment, the conditions include that the recorded shift amount is larger than the prespecified shift amount. Thus, setting, as the prespecified shift amount, such a shift amount as maintenance and inspection of the camera 300 becomes necessary allows the notification unit 214 to notify that maintenance and inspection of the camera 300 is necessary when a shift amount larger than that shift amount is calculated.

In the system 50 of the embodiment, the conditions include that the frequency with which the recorded shift amount has become larger than the prespecified shift amount is higher than a prespecified frequency. Thus, setting, as the prespecified frequency, such a frequency as maintenance and inspection of the camera 300 becomes necessary allows the notification unit 214 to notify that maintenance and inspection of the camera 300 is necessary when a frequency higher than that frequency is detected.

In the system 50 of the embodiment, the conditions include that the increase rate of the recorded shift amount is higher than the prespecified increase rate. Thus, setting, as the prespecified increase rate, such an increase rate as maintenance and inspection of the camera 300 becomes necessary allows the notification unit 214 to notify that maintenance and inspection of the camera 300 is necessary when an increase rate higher than the increase rate is detected.

### B. Other Embodiments 1

(B1) In the above-described embodiment, the system 50 may have a configuration that does not include the shift amount recording unit 213 and the notification unit 214. This configuration can also reduce the likelihood that the accuracy of position estimation decreases due to a shift of the correspondence relationship between the reference object and the coordinate in the real space resulting from a shift of the position of the camera 300.

(B2) In the above-described embodiment, the reference object is the marker MR showing a cross, but the present disclosure is not limited thereto. The figure is not limited to a cross and may be an arbitrary shape. The reference object may be an arbitrary object. A plurality of reference objects may be provided within the same angle of view. Providing a plurality of reference objects can further improve the accuracy of position estimation.

(B3) In the above-described embodiment, an arbitrary condition may be set as the prespecified condition to be determined by the notification unit 214.

(B4) In the above-described embodiment, the server 200 may be an information processing device of an arbitrary configuration.

(B5) In the above-described embodiment, the memories 112, 202 may be arbitrary storage devices. Examples of such storage devices include a hard disc drive (HDD), a solid-state drive (SDD), and a dynamic random access memory (DRAM).

(B6) In the above-described embodiment, the system 50 is used in the factory FC, but the present disclosure is not limited thereto. The system 50 may be used in an arbitrary facility.

(B7) In the above-described embodiment, the estimation unit 212 estimates the position of the object using a coordinate transformation matrix, but the present disclosure is not limited thereto. The estimation unit 212 may estimate the position of the object by an arbitrary method using image data and a shift amount.

### C. Other Embodiments 2

(C1) In the above-described embodiment, the process from acquisition of the vehicle position information to generation of the travel control signal is executed by the server 200. On the other hand, at least part of the process from acquisition of the vehicle position information to generation of the travel control signal may be executed by the vehicle 100. For example, the following Forms (1) to (3) may be adopted. (1) The server 200 may acquire the vehicle position information, determine the target position for which the vehicle 100 should head next, and generate a route from the current location of the vehicle 100 indicated in the acquired vehicle position information to the target position. The server 200 may generate a route to the target position between the current location and the destination, or may generate a route to the destination. The server 200 may transmit the generated route to the vehicle 100. The vehicle 100 may generate a travel control signal such that the vehicle 100 travels along the route received from the server 200, and may control the actuator cluster 120 using the generated travel control signal.

(2) The server 200 may acquire the vehicle position information and transmit the acquired vehicle position information to the vehicle 100. The vehicle 100 may determine a target position for which the vehicle 100 should head next, generate a route from the current position of the vehicle 100 indicated in the received vehicle position information to the target position, generate a travel control signal such that the vehicle 100 travels along the generated route, and control the actuator cluster 120 using the generated travel control signal. (3) In Forms (1) and (2) described above, the vehicle 100 may be equipped with an internal sensor, and a detection result output from the internal sensor may be used for at least either generation of a route or generation of a travel control signal. The internal sensor is a sensor installed in the vehicle 100. Examples of internal sensors include a sensor that detects a kinetic state of the vehicle 100, a sensor that detects an operation state of each part of the vehicle 100, and a sensor that detects an environment around the vehicle 100.

Specifically, internal sensors can include, for example, a camera, a LiDAR, a millimeter-wave radar, an ultrasonic sensor, a GPS sensor, an acceleration rate sensor, and a gyro sensor. For example, in Form (1) described above, the server 200 may acquire a detection result of an internal sensor, and when generating a route, reflect the detection result of the internal sensor on the route. In Form (1) described above, the vehicle 100 may acquire a detection result of an internal sensor, and when generating a travel control signal, reflect the detection result of the internal sensor on the travel control signal. In Form (2) described above, the vehicle 100 may acquire a detection result of an internal sensor, and when generating a route, reflect the detection result of the internal sensor on the route. In Form (2) described above, the vehicle 100 may acquire a detection result of an internal sensor, and when generating a travel control signal, reflect the detection result of the internal sensor on the travel control signal.

(C2) In the above-described embodiment, the server 200 automatically generates a travel control signal to be transmitted to the vehicle 100. On the other hand, the server 200 may generate a travel control signal to be transmitted to the vehicle 100 in accordance with an operation by an external operator present outside the vehicle 100. For example, an external operator may operate a steering device including a display that displays a captured image output from the camera 300, a steering wheel, an accelerator pedal, and a brake pedal for remotely operating the vehicle 100, and a communication device for communicating with the server 200 by wired communication or wireless communication, and the server 200 may generate a travel control signal according to an operation performed on the steering device.

(C3) In the above-described embodiment, the vehicle 100 should at least include components that allow the vehicle 100 to move by unmanned driving. For example, a form of a platform including the following components may be adopted. Specifically, the vehicle 100 should include at least the vehicle control device 110 and the actuator cluster 120 to exhibit the three functions of “running,” “turning,” and “stopping” by unmanned driving. In the case where the vehicle 100 acquires information from the outside for unmanned driving, the vehicle 100 should further include the communication device 130. That is, in the vehicle 100 that can move by unmanned driving, at least some of interior parts, such as a driver's seat and a dashboard, need not be provided, and at least some of exterior parts, such as a bumper and a fender, need not be provided, and a body shell need not be mounted. In this case, the other parts, such as the body shell, may be mounted on the vehicle 100 before the vehicle 100 is shipped from the factory FC, or the other parts, such as the body shell, may be mounted on the vehicle 100 after the vehicle 100 is shipped from the factory FC in a state where the other parts, such as the body shell, are not mounted on the vehicle 100. Each part may be mounted from an arbitrary direction, such as from an upper side, a lower side, a front side, a rear side, a right side, or a left side of the vehicle 100, and each part may be mounted from the same direction or a different direction. In the form of the platform, too, position determination can be performed in the same manner as in the vehicle 100 in the embodiment.

(C4) The vehicle 100 may be manufactured by combining a plurality of modules. A module means a unit composed of one or more parts that are put together according to the configuration or function of the vehicle 100. For example, the platform of the vehicle 100 may be manufactured by combining a front module constituting a front part of the platform, a center module constituting a center part of the platform, and a rear module constituting a rear part of the platform. The number of modules composing the platform is not limited to three and may instead be two or less or four or more. In addition to or in place of the platform, parts different from the platform in the vehicle 100 may be made into a module. Various modules may include an arbitrary exterior part, such as a bumper or a grill, or an arbitrary interior part, such as a seat or a console. Without being limited to the vehicle 100, a movable body of an arbitrary form may be manufactured by combining a plurality of modules. Such a module may be manufactured by, for example, joining a plurality of parts together by welding, fixing tools, etc., or by integrally molding at least some parts of the module as one part by casting. The molding method that integrally molds at least some parts of a module as one part is also called giga casting or mega casting. By using giga casting, it is possible to form, as one part, parts of a movable body that has been conventionally formed by joining a plurality of parts together. For example, the aforementioned front module, center module, and rear module may be manufactured using giga casting.

(C5) Transporting the vehicle 100 using unmanned driving of the vehicle 100 is also called “self-propelled transport.” A configuration for realizing self-propelled transport is also called “vehicle remote control autonomous transport system.” A production system that produces the vehicle 100 using self-propelled transport is also called “self-propelled transport.” In self-propelled production, for example, at least part of the transport of the vehicle 100 is realized by self-propelled transport in the factory FC that manufactures the vehicle 100.

(C6) In the above-described embodiment, some or all of the functions and processes realized by software may be realized by hardware. Some or all of the functions and processes realized by hardware may be realized by software. As the hardware for realizing various functions in the above-described embodiment, for example, various circuits such as an integrated circuit or a discrete circuit may be used.

The present disclosure is not limited to the above-described embodiment, and can be realized in various configurations within such a range that no departure is made from the gist of the disclosure. For example, the technical characteristics in the embodiment corresponding to the technical characteristics in the forms described in SUMMARY OF THE DISCLOSURE can be substituted or combined as appropriate to solve some or all of the above-described problems or to achieve some or all of the above-described effects. Unless a technical characteristic is described as essential in the present specification, that technical characteristic can be omitted as appropriate.

What is claimed is:

1. A system that estimates a position of an object in a facility, the system comprising:
an acquisition unit that acquires image data output by a camera fixed in the facility, the image data including the object and a reference object provided in the facility;
a calculation unit that calculates a shift amount between a prespecified reference position of the reference object and a position of the reference object in the acquired image data; and
an estimation unit that estimates the position of the object using the acquired image data and the calculated shift amount.

2. The system according to claim 1, wherein the reference object is a marker showing a prespecified figure.

3. The system according to claim 2, wherein the figure is a cross.

4. The system according to claim 2, wherein a plurality of reference objects is provided.

5. The system according to claim 1, further comprising:
a shift amount recording unit that records the calculated shift amount; and
a notification unit that, when a prespecified condition about the recorded shift amount is met, notifies that maintenance and inspection of the camera is necessary.

6. The system according to claim 5, wherein the condition includes that the recorded shift amount is larger than a prespecified shift amount.

7. The system according to claim 5, wherein the condition includes that a frequency with which the recorded shift amount has become larger than a prespecified shift amount is higher than a prespecified frequency.

8. The system according to claim 5, wherein the condition includes that an increase rate of the recorded shift amount is higher than a prespecified increase rate.
